(19) United States
(12) Patent Application Publication
(10) Pub. No.: US 2012/0140141 A1
(43) Pub. Date: Jun. 7, 2012

(54) Liquid crystal display device and method of manufacturing the same

(76) Inventors: Sang-Hoon Lee, Yongin-City (KR); Tae-Jin Kim, Yongin-City (KR)

(21) Appl. No.: 13/137,459

(22) Filed: Aug. 17, 2011

(30) Foreign Application Priority Data
Dec. 6, 2010 (KR) 10-2010-0123478

(51) Int. Cl. G02F 1/1333; H01J 9/24

(52) U.S. Cl. 349/59; 445/24

(57) ABSTRACT

A liquid crystal display device includes a liquid crystal display panel having a first surface and a second surface facing the first surface. The device includes a light guide panel having a light guiding portion facing the second surface of the liquid crystal display panel and a support protruding from the light guiding portion to the liquid crystal display panel. The device further includes an optical film interposed between the light guiding portion and the second surface of the liquid crystal display panel, and a frame that houses the liquid crystal display panel, the light guide panel, and the optical film. The device also includes a shielding portion interposed at least between the light guide panel and the frame.

### CROSS-REFERENCE TO RELATED PATENT APPLICATION

This application claims the benefit of Korean Patent Application No. 10-2010-0123478, filed on Dec. 6, 2010, in the Korean Intellectual Property Office, the disclosure of which is incorporated herein in its entirety by reference.

### BACKGROUND

1. Field

Embodiments relate to a liquid crystal display device and a method of manufacturing the same, and to a liquid crystal display device including a backlight unit having, e.g., an improved structure, and a method of manufacturing the same.

2. Description of the Related Art

A liquid crystal display (LCD) device may be a flat panel display device for, e.g., displaying an image by controlling the intensity of a transmitted light beam according to an image signal. In particular, the application range of LCD devices may be extensive because they can be manufactured as being lightweight, as a thin film, and as having low power consumption.

LCD devices may form an image by using light irradiated from a backlight unit. The light irradiated from a backlight unit may need to propagate substantially or only toward a liquid crystal display panel. However, some of, the light may leak out, e.g., through a space between the liquid crystal display panel and a frame, thereby reducing screen visibility.

Also, a mold for assembling the liquid crystal display panel and the backlight unit may be a plastic extrusion product and difficult to form as a thin film, which can cause an increase in dead space.

### SUMMARY

Embodiments may be realized by providing a liquid crystal display device including a liquid crystal display panel having a first surface and a second surface facing the first surface. The device includes a light guide panel having a light guiding portion facing the second surface of the liquid crystal display panel and a support protruding from the light guiding portion to the liquid crystal display panel. The device includes an optical film interposed between the light guiding portion and the second surface of the liquid crystal display panel, and a frame for housing the liquid crystal display panel, the light guide panel, and the optical film. The device includes a shielding portion interposed at least between the light guide panel and the frame.

The support of the light guide panel may protrude from a surface of the light guiding portion facing the second surface.

The support may be formed along an edge of the light guiding portion.

The optical film may be placed in a region defined by the support.

The shielding portion may be disposed between a side surface of the support and the frame.

The shielding portion may be disposed between the light guide panel and the frame and between the liquid crystal display panel and the frame.

The shielding portion may include a resin material.

The shielding portion may contact the light guide panel and the frame.

The shielding portion may have an even surface that is parallel to a side surface of the frame.

Embodiments may also be realized by providing a method of manufacturing a liquid crystal display device that includes preparing a liquid crystal display panel having a first surface and a second surface facing the first surface. The method includes preparing a light guide panel having a light guiding portion facing the second surface of the liquid crystal display panel and a support protruding from the light guiding portion to the liquid crystal display panel. The method includes assembling the liquid crystal display panel and the light guide panel, with an optical film between the light guiding portion and the second surface of the liquid crystal display panel, and forming a first shielding portion using a resin material at least between the light guide panel and a frame. The method includes forming a second shielding portion by planarizing a surface of the first shielding portion, and housing the assembled structure including the liquid crystal display panel and the light guide panel in the frame, with an even surface of the second shielding portion contacting the frame.

The forming of the second shielding portion may include pressuring the surface of the first shielding portion with a heated chassis.

### BRIEF DESCRIPTION OF THE DRAWINGS

Features will become more apparent to those of ordinary skill in the art by describing in detail exemplary embodiments with reference to the attached drawings in which:

FIG. 1 illustrates a cross-sectional view of a liquid crystal display device according to an exemplary embodiment; and

FIGS. 2 through 4 illustrate cross-sectional views for sequentially explaining a method of manufacturing a liquid crystal display device according to an exemplary embodiment, in which FIGS. 2 through 4 illustrate partial portions of an exemplary liquid crystal display device.

### DETAILED DESCRIPTION

Hereinafter, embodiments will be described in detail with reference to the attached drawings. Example embodiments, however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or element, it can be directly on the other layer or element, or intervening layers may also be present.

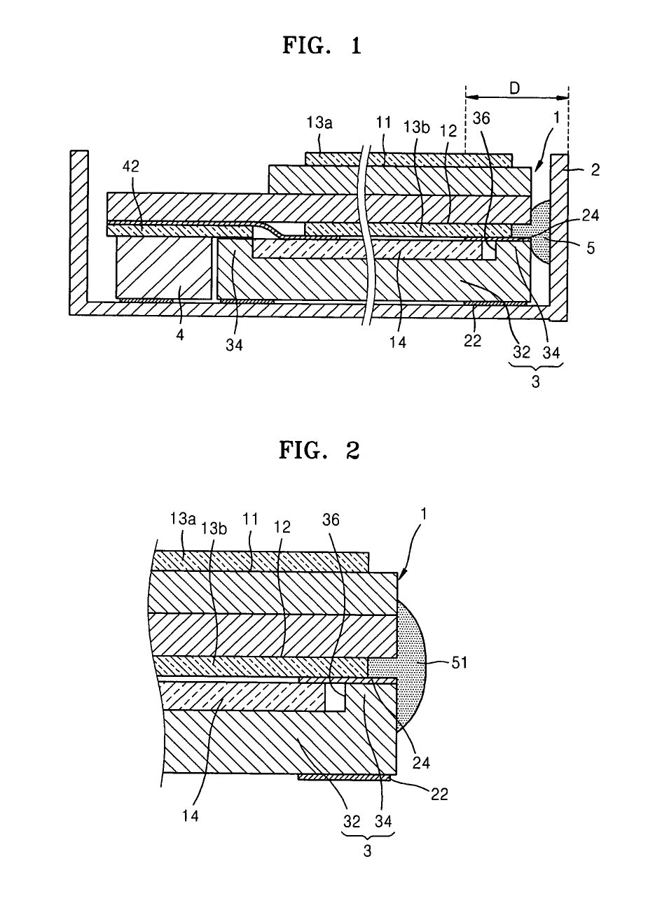

FIG. 1 is a cross-sectional view of a liquid crystal display device according to an embodiment of the present invention.

The liquid crystal display device according to an exemplary embodiment may include a liquid crystal display panel 1 for, e.g., forming an image. The liquid crystal display device may include a light guide panel 3 facing the liquid crystal display panel 1. The liquid crystal display device may include an optical film 14 interposed between the light guide panel 3 and the liquid crystal display panel 1. The liquid crystal display device may include a frame 2 for, e.g., housing the liquid crystal display panel 1, the light guide panel 3, and the optical film 14. The liquid crystal display device may include a shielding portion 5 that is interposed at least between the light guide panel 3 and the frame 2.

The liquid crystal display panel 1 may include two coupled substrates and a liquid crystal (not shown) interposed between the substrates. The liquid crystal display panel 1 may have a first surface 11 and a second surface 12 facing the first surface 11, in which the first and second surfaces 11 and 12 are exposed outside of the liquid crystal display panel 1. An image may be formed at the first surface 11. Light irradiated from a backlight unit may enter the liquid crystal display panel 1 through the second surface 12.

Polarizing films 13a and 13b may be attached to the first surface 11 and the second surface 12, respectively. The polarizing film 13a may be on, e.g., directly on, the first surface 11. The polarizing film 13b may be on, e.g., directly on, the second surface 12.

The optical film 14 may be disposed outside the polarizing film 13b attached to the second surface 12. For example, the optical film 14 may be disposed on a surface of the polarizing film 13b opposing the surface of the polarizing film 13b attached to the second surface 12. The optical film 14 may include, e.g., a prism sheet, a diffusion sheet, etc.

The optical film 14 may be interposed between the polarizing film 13b attached to the second surface 12 of the liquid crystal display panel 1 and the light guide panel 3.

According to an exemplary embodiment, the light guide panel 3 may include a light guiding portion 32 and a support 34.

The light guiding portion 32 may face the second surface 12 of the liquid crystal display panel 1. The light guide portion 32 may guide light irradiated from, e.g., a light-emitting diode (LED) lamp 4, toward the liquid crystal display panel 1. The light guiding portion 32 may be formed as an even panel parallel to the second surface 12 of the liquid crystal display panel 1.

The support 34 may be located at, e.g., an edge of the light guiding portion 32. The support 34 may protrude from the light guiding portion 32 in a direction toward the liquid crystal display panel 1. The support 34 may be a protruding portion formed on a surface of the light guiding portion 32. The support 34 and the light guiding portion 32 may form one continuous layer. The support 34 may overlap the liquid crystal display panel 1.

A protrusion height of the support 34 may be equal to or slightly greater than a thickness of the optical film 14.

Accordingly, as illustrated in FIG. 1, the light guide panel 3 may have a protruding edge and a recessed central portion. However, embodiments are not limited thereto. For example, the support 34 may protrude from only a portion of the edge of the light guiding portion 32, or the support 34 may protrude forming a closed loop along the entire edge of the light guiding portion 32. Thus, an inlet portion 36 that is concave may be formed in a central portion of the light guide panel 3. The inlet portion 36 may allow the optical film 14 to be safely placed in the inlet portion 36. As such the optical film 14 may be disposed on the light guiding portion 32 and may be surrounded by the support 34.

A LED lamp 4 may be located at a side of the light guide panel 3. The LED lamp 4 may be mounted on a circuit board 42, which may be located at a side of the light guide panel 3. A portion of the circuit board 42 and a portion of the support 34 of the light guide panel 3 may overlap and thus, the circuit board 42 may be supported by the support 34.

The liquid crystal display panel 1, to which the polarizing films 13a and 13b may be attached, may be disposed on a top surface of the support 34. The liquid crystal display panel 1 or the polarizing film 13b on the liquid display panel 1 may be attached to the support 34 with, e.g., a first double-sided adhesive tape 24. The light guide panel 3 may be attached to the frame 2 with, e.g., a second double-sided adhesive tape 22.

An assembly including the liquid crystal display panel 1, the light guide panel 3, and the LED lamp 4 may be housed by the frame 2. The frame 2 may be a chassis formed of, e.g., metal.

According to an exemplary embodiment, as illustrated in FIG. 1, the shielding portion 5 may be disposed at least between the light guide panel 3 and the frame 2. As such, the shielding portion 5 may be at least on a lateral end of the light guide panel 3. The shielding portion 5 may also extend from the lateral end of the light guide panel 3 to an adjacent lateral end of the liquid crystal display panel 1.

The shielding portion 5 may be disposed at least between an outer surface of the support 34 of the light guide panel 3 and the frame 2. The shielding portion 5 may minimize, reduce, and/or prevent light that is irradiated from the LED lamp 4, in a direction in which an image is formed, and enters the liquid crystal display panel 1 via the light guide panel 3 from leaking through a space between the light guide panel 3 and the frame 2.

Due to the light guide panel 3 including the light guiding portion 32 and the support 34, it may not be necessary to use a separate mold frame for supporting the optical film 14 and the light guide panel 3. Thus, a width D of dead space outside where an image is formed may be reduced. When a mold frame is a plastic extrusion product, a dead space may be in a range of 2.1 to 2.2 mm. However, in the embodiment described with reference to FIG. 1, the dead space may be reduced to, e.g., as small as about 1.0 mm.

The shielding portion 5 may be formed to have various shapes by using, e.g., a resin material. The shielding portion 5 may be formed by, e.g., injecting a resin material between the light guide panel 3 and an area where the frame 2 will be attached. The shielding portion 5 may be formed by, e.g., injecting a resin material between the light guide panel 3 and the frame 2. For example, the resin material for forming the shielding portion 5 may be injected between the light guide panel 3 and the frame 2 after the light guide panel 3 and the LED lamp 4 are assembled with the frame 2.

The shielding portion 5 may contact the frame 2 as well as the light guide panel 3. Thus, the leakage of light irradiated from the LED lamp 4 may be further minimized, reduced, and/or prevented.

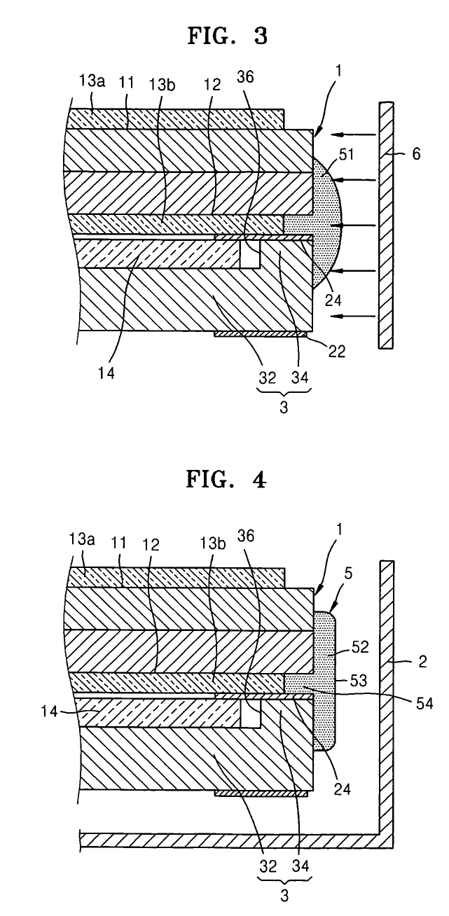

FIGS. 2 through 4 are cross-sectional views for sequentially explaining a method of manufacturing a liquid crystal display device according to an exemplary embodiment, in which FIGS. 2 through 4 illustrate partial portions of a liquid crystal display device.

First, the optical film 14 may be placed in the inlet portion 36 of the light guide panel 3, including the light guiding portion 32 and the support 34. Then, the liquid crystal display panel 1 to which the polarizing films 13a and 13b are attached may be attached to the support 34 with the first double-sided adhesive tape 24, thereby forming an assembly.

A resin material may be applied to a side surface of the assembly, that is, the outer side of the support 34 and an outer side surface of the liquid crystal display panel 1, to form a first shielding portion 51. At this stage, the resin material of the first shielding portion 51 may not yet be hardened.

Then, as illustrated in FIG. 3, the first shielding portion 51 may be hardened to form a second shielding portion 52. For example, the first shielding portion 51 may be hardened by pressure by using a heated heating bar 6. The second shielding portion 52 may have an even surface 53, as illustrated in FIG. 4. At this stage, the second shielding portion 52 may have a hardened state formed by the heating bar 6.

The even surface 53 of the second shielding portion 52 may be parallel to the outer side surface of the support 34 and/or the outer side surface of the liquid crystal display panel 1, and may also be parallel to a side surface of a side wall of the frame 2.

The shielding portion 5 may also include a filler portion 54. The filler portion 54 may form a continuous layer with the second shielding portion 52. The filler portion 54 may be disposed between the second surface 12 and the support 34. The filler portion 54 may be adjacent to, e.g., directly on, a lateral end of the polarizing film 13b, the second surface 12, and the adhesive 24 on the upper surface of the support 34.

Then, the light guide panel 3 may be attached to the frame 2 with, e.g., the second double-sided adhesive tape 22. In this regard, the even surface 53 of the second shielding portion 52 may contact the side surface of the side wall of the frame 2.

Thus, the center of the liquid crystal display panel 1 may be easily matched with the center of the light guide panel 3 and misalignment of the centers may be minimized, reduced, and/or prevented. In addition, since the shielding portion 5 may easily contact the side surface of the side wall of the frame 2 and the outer side surface of the light guide panel 3, leakage of light through a space between the light guide panel 3 and the frame 2 may be minimized, reduced, and/or prevented.

By way of summation and review, according to the above exemplary embodiments, leakage of light that is irradiated from, e.g., a LED lamp, and that enters a light guide panel through a space between the light guide panel and a frame in a direction in which an image is formed may be minimized, reduced, and/or prevented by using a shielding portion.

Due to the use of the light guide panel including a light guide portion and a support, a separate mold frame for supporting an optical film and a liquid crystal display panel may not be necessary and thus, a width of a dead space outside where an image is formed may be reduced.

A center of a liquid crystal display panel may be easily matched with a center of the light guiding panel, and misalignment of the centers may be minimized, reduced, and/or prevented.

Since the shielding portion may easily contact the side surface of the side wall of the frame and the outer side surface of the light guide panel, leakage of light through the space between the light guide panel and the frame may be minimized, reduced, and/or prevented.

Embodiments provide a liquid crystal display device for minimizing, reducing, and/or preventing leakage of light irradiated from a backlight unit at an edge of a panel and reducing dead space, and a method of manufacturing the same.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as defined by the following claims.

What is claimed is:

1. A liquid crystal display device, comprising:
a liquid crystal display panel having a first surface and a second surface facing the first surface;
a light guide panel including:
a light guiding portion facing the second surface of the liquid crystal display panel, and
a support protruding from the light guiding portion toward the liquid crystal display panel;
an optical film interposed between the light guiding portion and the second surface of the liquid crystal display panel;
a frame that houses the liquid crystal display panel, the light guide panel, and the optical film; and
a shielding portion interposed at least between the light guide panel and the frame.

2. The liquid crystal display device as claimed in claim 1, wherein the support of the light guide panel protrudes from a surface of the light guiding portion facing the second surface.

3. The liquid crystal display device as claimed in claim 1, wherein the support of the light guide panel is on an edge of the light guiding portion.

4. The liquid crystal display device as claimed in claim 3, wherein the optical film is in a region defined by the support of the light guide panel.

5. The liquid crystal display device as claimed in claim 1, wherein the shielding portion is between a side surface of the support of the light guide panel and the frame.

6. The liquid crystal display device as claimed in claim 1, wherein the shielding portion is between the light guide panel and the frame and between the liquid crystal display panel and the frame.

7. The liquid crystal display device as claimed in claim 1, wherein the shielding portion includes a resin material.

8. The liquid crystal display device as claimed in claim 1, wherein the shielding portion contacts the light guide panel and the frame.

9. The liquid crystal display device as claimed in claim 1, wherein the shielding portion has an even surface that is parallel to a side surface of the frame.

10. A method of manufacturing a liquid crystal display device, the method comprising:
preparing a liquid crystal display panel having a first surface and a second surface facing the first surface;
preparing a light guide panel including a light guiding portion facing the second surface of the liquid crystal display panel and a support protruding from the light guiding portion toward the liquid crystal display panel;
assembling the liquid crystal display panel and the light guide panel such that an optical film is between the light guiding portion of the light guide panel and the second surface of the liquid crystal display panel;
forming a first shielding portion using a resin material at least at a lateral end of the light guide panel;
forming a second shielding portion by planarizing a surface of the first shielding portion; and
housing the assembled structure including the liquid crystal display panel and the light guide panel in a frame such that an even surface of the second shielding portion contacts the frame.

11. The method as claimed in claim 10, wherein the forming of the second shielding portion includes pressuring the surface of the first shielding portion with a heated chassis.
